(19) United States
(12) Patent Application Publication
(10) Pub. No.: US 2020/0286205 A1
(43) Pub. Date: Sep. 10, 2020

(54) PRECISE 360-DEGREE IMAGE PRODUCING METHOD AND APPARATUS USING ACTUAL DEPTH INFORMATION

(71) Applicant: KOREA UNIVERSITY RESEARCH AND BUSINESS FOUNDATION, Seoul (KR)

(72) Inventors: Nak Ju DOH, Seoul (KR); Hyung A CHOI, Anyang-si (KR); Bum Chul JANG, Seoul (KR)

(73) Assignee: Korea University Research and Business Foundation, Seoul (KR)

(21) Appl. No.: 16/638,224

(22) PCT Filed: Oct. 4, 2019
(86) PCT No.: PCT/KR2019/013030

§ 371 Date: Feb. 12, 2020

(30) Foreign Application Priority Data
Oct. 4, 2018 (KR) 10-2018-0118379

(51) Int. Cl. G06T 3/00; H04N 5/232; G06T 7/55

(52) U.S. Cl. CPC G06T 3/0087; G06T 2207/10028; G06T 7/55; H04N 5/23238

(57) ABSTRACT

The 360-degree image producing method according to an embodiment of the present invention includes: an information receiving step of receiving 360-degree image producing information including a plurality of camera images, pose information, position information, depth information, a camera model, and a 360-degree model; a target selecting step of selecting a depth information point corresponding to a target pixel included in the 360-degree image among a plurality of points included in the depth information, using the position information, the 360-degree model and the depth information; an image pixel value acquiring step of acquiring a pixel value of a pixel of a camera image corresponding to the depth information point among the plurality of camera images; and a target pixel constructing step of constructing a pixel value of the target pixel.

### TECHNICAL FIELD

The present invention relates to a method and an apparatus for constructing a more precise 360-degree image by simultaneously utilizing depth information actually measured in a space during a process of generating a plurality of images simultaneously acquired using a plurality of cameras as one 360-degree image.

### BACKGROUND ART

A technique of reconstructing superimposed images has been frequently used to produce a 360-degree image. That is, when the 360-degree image is produced, a technique of acquiring images by superposing fields of view of a plurality of cameras and then reconstructing the images as one image without causing a missed portion in a space has been widely used.

More specifically, a 360-degree image includes several types of images such as a panoramic image using a two-dimensional coordinate system and a cubic image using a three-dimensional coordinate system. When a plurality of camera images is reconstructed as one 360-degree image, a simple geometry such as a sphere with a specific diameter (see FIG. 2) or a cube is assumed, images captured from individual cameras are projected onto the geometry, and information about the projected geometry is reprojected onto a panoramic or cubic image to generate a 360-degree image.

In this case, referring to FIG. 3, due to an inaccuracy of the geometry during the projection step, the images acquired by different cameras may not be accurately matched in the reconstructed image.

Therefore, there is a necessity of a method and an apparatus for producing a precise 360-degree image using depth information to solve the mismatching problem of images according to the related art.

### DISCLOSURE

### Technical Problem

An object of the present invention is to provide a method and an apparatus for generating a more precise 360-degree image by simultaneously utilizing geometric information acquired from the same space when a 360-degree image such as a panoramic image or a cubic image is generated from a plurality of camera images.

Technical problems of the present invention are not limited to the above-mentioned technical problem(s), and other technical problem(s), which are not mentioned above, can be clearly understood by those skilled in the art from the following descriptions.

### Technical Solution

In order to achieve the above-described object, a 360-degree image producing method according to the present invention which is a method for producing a 360-degree image for a predetermined space, includes an information receiving step of receiving 360-degree image producing information including a plurality of camera images photographed using at least one camera, pose information which is information about a position and a direction of a camera which photographs the plurality of camera images, position information which is information about an origin position of the 360-degree image, depth information which is information about points corresponding to a plurality of depth values measured in the space, a camera model representing a correlation between a pixel included in the plurality of camera images and a point included in the depth information, and a 360-degree model representing a correlation between a pixel included in the 360-degree image and the point included in the depth information; a target selecting step of selecting a depth information point corresponding to a target pixel which is included in the 360-degree image among a plurality of points included in the depth information, using the position information, the 360-degree model and the depth information; an image pixel value acquiring step of acquiring a pixel value of a pixel of a camera image corresponding to the depth information point among the plurality of camera images using the pose information, the camera model, and the depth information; and a target pixel constructing step of constructing a pixel value of the target pixel using the acquired pixel value of the camera image.

Desirably, between the target selecting step and the image pixel value acquiring step, the 360-degree image producing method may further include a multiple correspondence confirming step of confirming whether the depth information point corresponds to pixels of two or more camera images among the plurality of camera images, in the target pixel constructing step, when the depth information point corresponds to pixels of two or more camera images, a predetermined weight value is assigned to each of the pixels of two or more camera images to construct a pixel value of the target pixel.

Desirably, the 360-degree image producing method may further include a 360-degree image generating step of generating the 360-degree image by repeatedly applying the target selecting step, the image pixel value acquiring step, the multiple correspondence confirming step, and the target pixel constructing step to all pixels included in the 360-degree image.

Desirably, the 360-degree image producing method may further include a three-dimensional map generating step of generating a three-dimensional map of a virtual space corresponding to the space by projecting the generated 360-degree image to geometry information based on the depth information.

Desirably, in the three-dimensional map generating step, a 360-degree image which represents an arbitrary field of view of the virtual space corresponding to the three-dimensional map is selected as a representative image and at least one 360-degree image other than the representative image to represent a missed field of view which cannot be represented by the representative image is designated as a supplementary image, and a projected image corresponding to an arbitrary field of view is generated by assigning a weight value to information of the representative image and the supplementary image to project the projected image onto the geometry information to generate the three-dimensional map.

In order to achieve the above-described object, a 360-degree image producing apparatus according to the present invention which is an apparatus for producing a 360-degree image for a predetermined space, includes a receiving unit which receives 360-degree image producing information including a plurality of camera images photographed using at least one camera, pose information which is information about a position and a direction of a camera which photographs the plurality of camera images, position information which is information about an origin position of the 360-degree image, depth information which is information about points corresponding to a plurality of depth values measured in the space, a camera model representing a correlation between a pixel included in the plurality of camera images and a point included in the depth information, and a 360-degree model representing a correlation between a pixel included in the 360-degree image and the point included in the depth information; a selecting unit which selects a depth information point corresponding to a target pixel which is included in the 360-degree image among a plurality of points included in the depth information, using the 360-degree model and the depth information; an acquiring unit which acquires a pixel value of a pixel of a camera image corresponding to the depth information point among the plurality of camera images using the pose information, the camera model, and the depth information; and a constructing unit which constructs a pixel value of the target pixel using the acquired pixel value of the camera image.

Desirably, the 360-degree image producing apparatus further includes: a confirming unit which confirms whether the depth information point corresponds to pixels of two or more camera images among the plurality of camera images and when the depth information point corresponds to pixels of two or more camera images, the constructing unit assigns a predetermined weight value to each of the pixels of two or more camera images to construct a pixel value of the target pixel.

Desirably, the 360-degree image producing apparatus further includes a generating unit which generates the 360-degree image by repeatedly applying the selecting unit, the acquiring unit, the confirming unit, and the constructing unit to all pixels included in the 360-degree image.

Desirably, the generating unit may further generate a three-dimensional map of a virtual space corresponding to the space by projecting the generated 360-degree image to geometry information based on the depth information.

Desirably, the generating unit selects a 360-degree image which represents an arbitrary field of view of the virtual space corresponding to the three-dimensional map as a representative image, designates at least one 360-degree image other than the representative image to represent a missed field of view which cannot be represented by the representative image as a supplementary image, and generates a projected image corresponding to an arbitrary field of view by assigning a weight value to information of the representative image and the supplementary image to project the projected image onto the geometry information to generate the three-dimensional map.

### Advantageous Effects

According to an image producing method and apparatus according to the embodiment of the present invention, with respect to the mismatching generated when two or more cameras photograph the same points and convert the photographed images into a 360-degree image as it is in the related art, depth data actually measured in the space are simultaneously utilized to construct a clear image which does not have distortion at a point where the mismatching is caused.

Further, the 360-degree image generated by the 360-degree image producing method and apparatus according to one embodiment of the present invention is generated through geometric information so that when the image is projected onto the corresponding geometry, the image and the geometric information match and when a three-dimensional map is implemented on a virtual space therethrough, the distortion due to the mismatching between the image and the geometry may not be caused.

Specifically, in order to completely restore an arbitrary field of view in a three-dimensional map, when a representative image which most satisfactorily represents an arbitrary field of view and a supplementary image for representing a missed field of view which cannot be represented by the representative image are selected and a weight value is assigned to all or some of pixels of the images, all the 360-degree images may be configured to match the geometric information by the image generating method and apparatus according to one embodiment of the present invention. Accordingly, even though a plurality of 360-degree images is simultaneously applied, the consistency is maintained with respect to the geometric information so that a clearer three-dimensional map may be implemented.

### DESCRIPTION OF DRAWINGS

FIG. 1 is a flowchart illustrating a precise 360-degree image producing method using depth information according to an embodiment of the present invention.

FIG. 2 is a 360-degree image which is projected onto a geometry having a spherical shape.

FIG. 3 is a 360-degree panoramic image with a distortion caused in a superimposed portion because images acquired by different cameras are not precisely matched.

FIG. 4 is an image illustrating an example in which the consistency of an indoor object is not maintained in a three-dimensional map due to the mismatching of the image and the shape.

FIG. 5 is a view illustrating an example in which depth information according to one embodiment of the present disclosure is given.

FIG. 6 is a view illustrating an example of the related art in which the depth information is not given.

FIG. 7 is a view illustrating an example in which depth information points according to one embodiment of the present invention is photographed by two or more cameras.

FIG. 8 is a flowchart illustrating a precise 360-degree image producing method using depth information according to another embodiment of the present invention.

FIG. 9 is a block diagram illustrating a precise 360-degree image producing apparatus using depth information according to an embodiment of the present invention.

### BEST MODE

Those skilled in the art may make various modifications to the present invention and the present invention may have various exemplary embodiments, and thus specific embodiments will be illustrated in the drawings and described in detail in the detailed description. However, it should be understood that the invention is not limited to the specific embodiments, but includes all changes, equivalents, or alternatives which are included in the spirit and technical scope of the present invention. In the description of respective drawings, similar reference numerals designate similar elements.

Terms such as first, second, A, or B may be used to describe various components, but the components are not limited by the above terms. The above terms are used only to discriminate one component from another component. For example, without departing from the scope of the present invention, a first component may be referred to as a second component, and similarly, a second component may be referred to as a first component. A term of and/or includes combination of a plurality of related elements or any one of the plurality of related elements.

It should be understood that, when it is described that an element is “coupled” or “connected” to another element, the element may be “directly coupled” or “directly connected” to the another element or “coupled” or “connected” to the another element through a third element. In contrast, when it is described that an element is “directly coupled” or “directly connected” to another element, it should be understood that no element is present therebetween.

Terms used in the present application are used only to describe a specific exemplary embodiment but are not intended to limit the present invention. A singular form may include a plural form if there is no clearly opposite meaning in the context. In the present application, it should be understood that term “include” or “have” indicates that a feature, a number, a step, an operation, a component, a part or the combination thoseof described in the specification is present, but do not exclude a possibility of presence or addition of one or more other features, numbers, steps, operations, components, parts or combinations, in advance.

If it is not contrarily defined, all terms used herein including technological or scientific terms have the same meaning as those generally understood by a person with ordinary skill in the art. Terms defined in generally used dictionary shall be construed that they have meanings matching those in the context of a related art and shall not be construed in ideal or excessively formal meanings unless they are clearly defined in the present application.

Hereinafter, exemplary embodiments according to the present invention will be described in detail with reference to accompanying drawings.

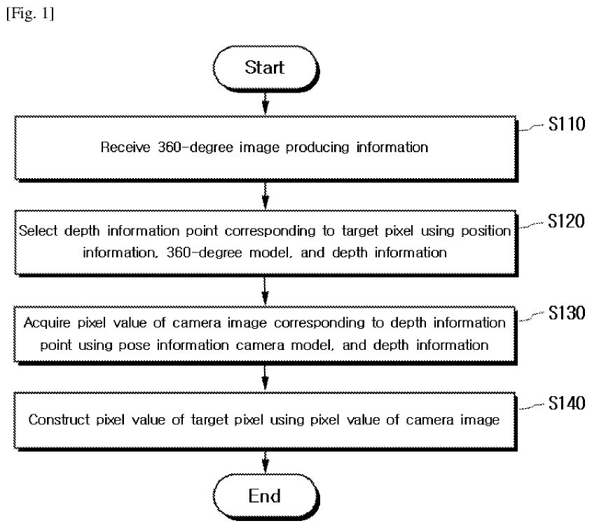

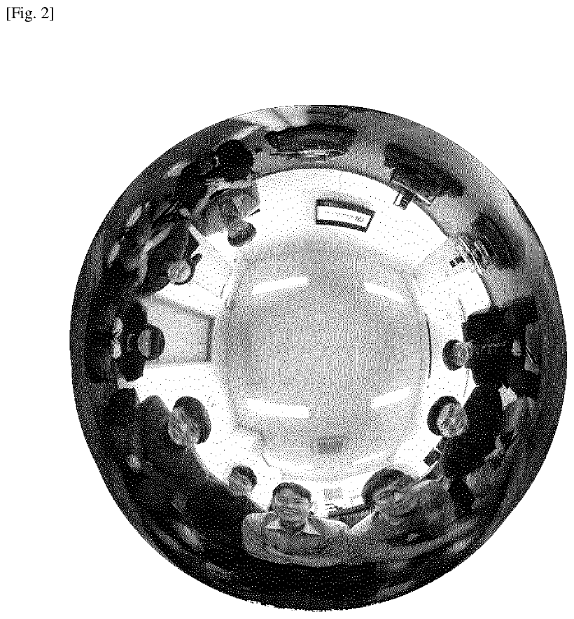

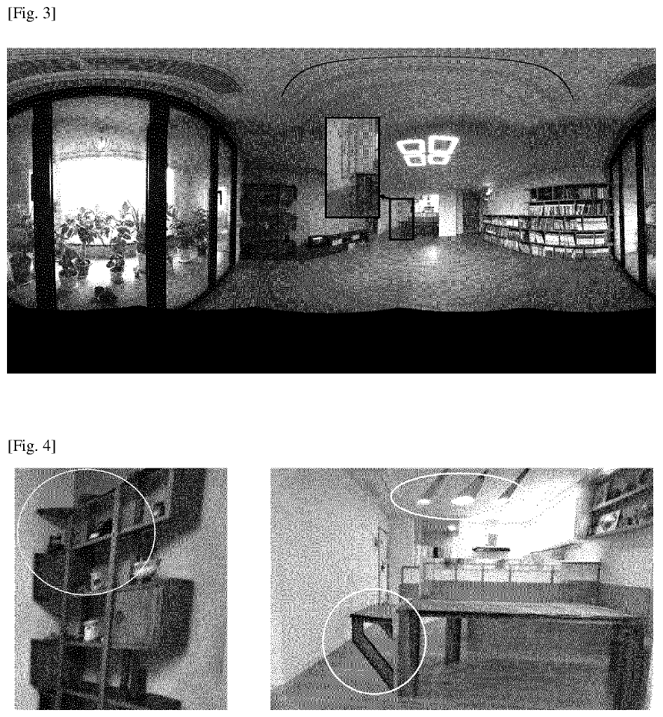

FIG. 1 is a flowchart illustrating a precise 360-degree image producing method using depth information according to an embodiment of the present invention.

In step S110, a 360-degree image producing apparatus may receive 360-degree image producing information including a plurality of camera images photographed using at least one camera, pose information which is information about a position and a direction of a camera which photographs the plurality of camera images, position information which is information about an origin position of the 360-degree image, depth information which is information about points corresponding to a plurality of depth values measured in the space, a camera model representing a correlation between a pixel included in the plurality of camera images and a point included in the depth information, and a 360-degree model representing a correlation between a pixel included in the 360-degree image and the point included in the depth information.

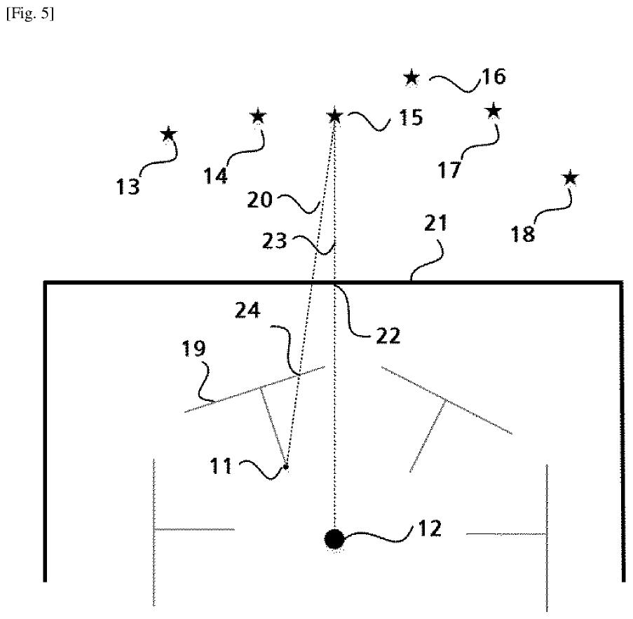

In this case, referring to FIGS. 5 to 7, the pose information of an origin of the camera may be three-dimensional pose information representing a position and a direction of an origin 11 of a specific camera. Further, position information of an origin of the 360-degree image may be three-dimensional position information of an origin 12 of a 360-degree image. Further, the depth information 13 to 18 may be depth information which is actually measured a plurality of times with respect to a specific coordinate system in a space which is photographed by the camera. Further, the camera image may be a camera image 19 photographed at a camera origin 11 photographed by the camera. Further, the camera model may be information which deduces a correlation between a specific pixel value in the camera image 19 and depth information 13 to 18. Further, the 360-degree model may be a constructive model 21 which constructs a correlation between a pixel value in the 360-degree image and depth information.

In the meantime, the pose information of the camera origin may be represented as a three-dimensional vector or represented by a polar coordinate system, a rotation matrix, or quaternion.

Further, the actual depth information represents space geometric information acquired by a sensor and is not limited to a type of an acquiring sensor and a represented shape.

More specifically, the actual depth information may be represented as a point cloud, a mesh, or a depth image and may be acquired by various sensors. A representative sensor may include a distance measuring sensor using a laser such as a scannerless type of LiDAR such as a time-of-flight camera or a scanning type of LiDAR such as Velodyne, or a 3D camera using structured light such as Kinect, RealSense, or Structure Sensor. Further, the depth information may also be measured using a 3D reconstruction technique using a plurality of images acquired by a single camera or a plurality of cameras.

Further, when a depth information point 15 is given in a space, the camera model is a model for finding a pixel 24 of a camera image 19 connected to the depth information point 15 by utilizing a ray casting 20 technique, and the like. In FIG. 5, even though a linear model with respect to a pin-hole camera is represented, when a fish-eye is used, different models may be used.

Further, the constructive model 21 of the 360-degree image generally represents the space as a three-dimensional sphere or cube and finds depth information in the space associated with the specific pixel 22 by using a ray-casting 23 technique and the like when a specific pixel 22 of the 360-degree image is selected from the sphere or the cube. For example, in FIG. 5, a three-dimensional cube is assumed and a 360-degree image constructive model 21 is illustrated based on a two-dimensional projective view, but it is not limited to an arbitrary shape.

In the meantime, the pose information, the position information, and the depth information may be values described based on a global coordinate system and specifically, the pose information and the position information may be used to convert a reference coordinate system of the depth information.

In step S120, a 360-degree image producing apparatus selects a depth information point corresponding to a target pixel which is a pixel included in a 360-degree image, among a plurality of points included in the depth information, using the position information, the 360-degree model, and the depth information.

When the target pixel 22 in the 360-degree image is specified, the 360-degree image producing apparatus may select the depth information point 15 corresponding to the target pixel 22 simultaneously using the 360-degree model 21 and the depth information 13 to 18.

In this case, the 360-degree image producing apparatus may change the coordinate system of the depth information into the reference coordinate system with respect to the origin position of the position information using the position information and the depth information based on the global coordinate system.

In step S130, the 360-degree image producing apparatus acquires a pixel value of a pixel of a camera image corresponding to the depth information point among the plurality of camera images using the pose information, the camera model, and the depth information.

For example, the 360-degree image producing apparatus may detect a corresponding depth information point 15 by the ray-casting 20 technique using the camera model and detect a camera image pixel value 24 corresponding thereto.

In this case, the 360-degree image producing apparatus may change the coordinate system of the depth information into the reference coordinate system with respect to the position and the direction of the camera included in the pose information using the pose information and the depth information based on the global coordinate system.

Finally, in step S140, the 360-degree image producing apparatus constructs a pixel value of a target pixel using the acquired pixel value of the camera image.

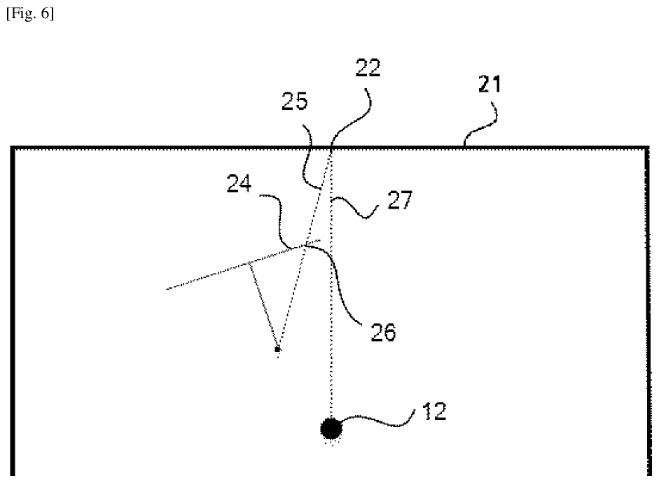

In this case, when the actual depth information is not used as described in the related art, as illustrated in FIG. 6, if only the 360-degree model 21 is used, the target pixel 22 is found by the relationship 27 of a 360-degree image origin 12 and the 360-degree model 21 and an image pixel value 26 corresponding thereto is found and in this case, an image information value different from an actual image pixel 24 is used so that there may be a problem in that distortion between the image and the depth information is caused.

According to another embodiment, between the target selecting step S120 and the image pixel value acquiring step S130, the 360-degree image producing apparatus may confirm (a step of confirming multiple correspondence) whether the depth information point corresponds to pixels of two or more camera images among the plurality of camera images and when the depth information point corresponds to the pixels of two or more camera images, construct a pixel values of a target pixel by assigning a predetermined weight value to each of the pixels of two or more camera images in a target pixel constructing step S140.

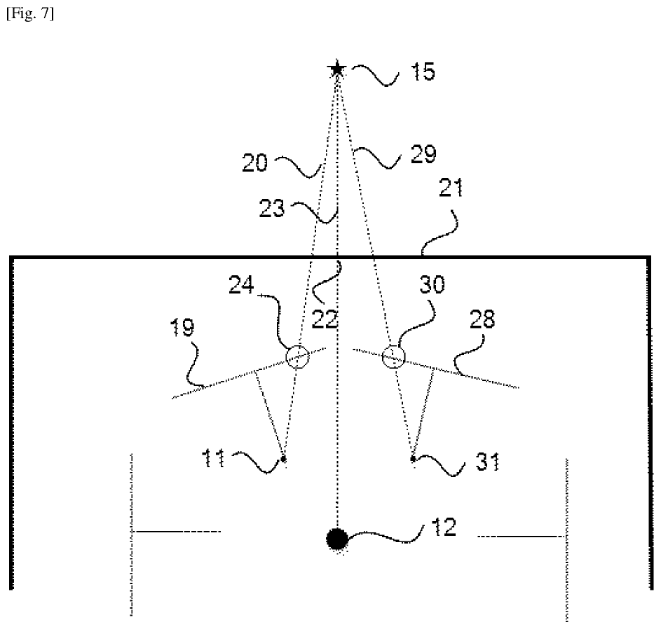

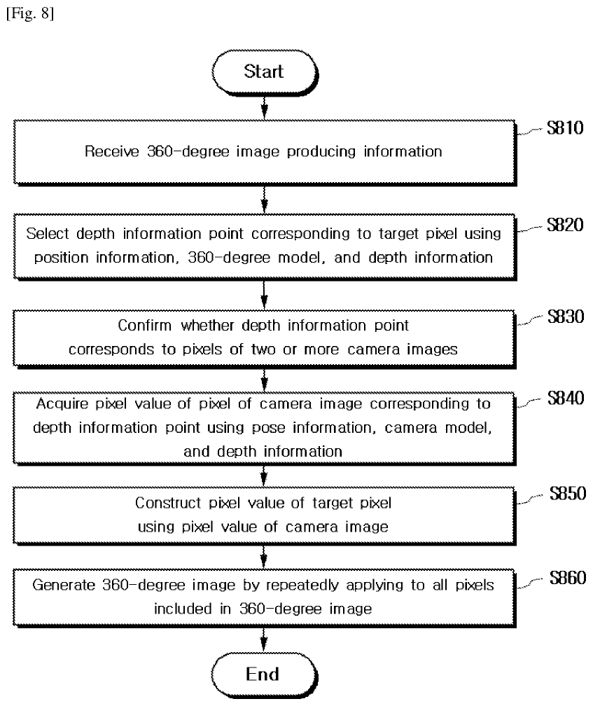

For example, the 360-degree image producing apparatus may additionally perform the multiple correspondence confirming step to confirm that in FIG. 7, the depth information point 15 corresponds to camera image pixels 24 and 30 of camera images by two or more different cameras.

In this case, the 360-degree image producing apparatus may find pixels 24 and 30 of camera images 19 and 28 associated with the depth information point 15 in a space of a camera model of each camera using the ray-casting 20 and 29 technique.

Further, when camera image pixels 24 and 30 of two camera images correspond in the multiple correspondence confirming step, the 360-degree image producing apparatus assigns a weight value to a plurality of corresponding camera image pixels 24 and 30 in the target pixel constructing step to construct a value of the target pixel 22.

According to another embodiment, the 360-degree image producing apparatus repeatedly applies the target selecting step S120, the image pixel value acquiring step S130, the multiple correspondence confirming step, the target pixel constructing step S140 to all pixels included in the 360-degree image to generate a 360-degree image.

According to another embodiment, the 360-degree image producing apparatus projects the generated 360-degree image onto geometric information to generate a three-dimensional map in a virtual space.

According to still another embodiment, the 360-degree image producing apparatus may generate a projected image using a representative image and a supplementary image.

That is, when the three-dimensional map is represented, the 360-degree image producing apparatus may select a 360-degree image which well represents an arbitrary field of view of the virtual space with a three-dimensional map as a representative image. Further, the 360-degree image producing apparatus may designate at least one 360-degree image other than the representative image, as a supplementary image to represent a missed field of view which cannot be represented by the representative image. Further, the 360-degree image producing apparatus assigns a weight value to information of the representative image and the supplementary image to generate a projected image corresponding to the arbitrary field of view.

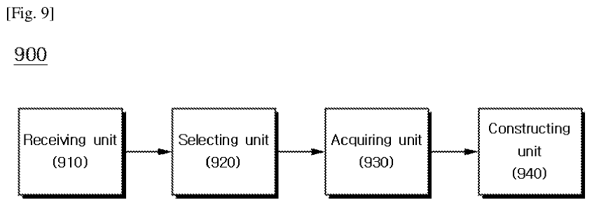

FIG. 9 is a block diagram illustrating a precise 360-degree image producing apparatus using depth information according to an embodiment of the present invention.

Referring to FIG. 9, a precise 360-degree image producing apparatus 900 using depth information according to an embodiment of the present disclosure may include a receiving unit 910, a selecting unit 920, an acquiring unit 930, and a constructing unit 940. Further, the 360-degree image producing apparatus 900 may further include a confirming unit (not illustrated) and a generating unit (not illustrated) as an option.

The receiving unit 910 receives 360-degree image producing information including a plurality of camera images photographed using at least one camera, pose information which is information about a position and a direction of a camera which photographs the plurality of camera images, position information which is information about an origin position of the 360-degree image, depth information which is information about points corresponding to a plurality of depth values measured in the space, a camera model representing a correlation between a pixel included in the plurality of camera images and a point included in the depth information, and a 360-degree model representing a correlation between a pixel included in the 360-degree image and the point included in the depth information.

The selecting unit 920 selects a depth information point corresponding to a target pixel which is included in a 360-degree image among a plurality of points included in the depth information using the position information, the 360-degree model, and the depth information.

The acquiring unit 930 acquires a pixel value of a pixel of a camera image corresponding to the depth information point among the plurality of camera images using the pose information, the camera model, and the depth information.

The constructing unit 940 constructs a pixel value of the target pixel using the acquired pixel value of the camera image.

The confirming unit (not illustrated) confirms whether the depth information point corresponds to pixels of two or more camera images among the plurality of camera images.

In this case, when the depth information point corresponds to pixels of two or more camera images, the constructing unit 940 may construct a pixel value of the target pixel by assigning a predetermined weight value to each of the pixels of two or more camera images.

The generating unit (not illustrated) generates a 360-degree image by repeatedly applying the selecting unit 910, the acquiring unit 920, the confirming unit (not illustrated), and the constructing unit 940 to all pixels included in the 360-degree image.

According to another embodiment, the generating unit (not illustrated) may further generate a three-dimensional map of a virtual space corresponding to a space by projecting the generated 360-degree image to geometry information based on the depth information.

According to another embodiment, the generating unit (not illustrated) selects a 360-degree image which represents an arbitrary field of view of a virtual space corresponding to a three-dimensional map as a representative image, designates at least one 360-degree image other than the representative image as a supplementary image to represent a missed field of view which cannot be represented by the representative image, assigns a weight value to information of the representative image and the supplementary image to generate a projected image corresponding to the arbitrary field of view to project the projected image onto the geometry information to generate a three-dimensional map.

The above-described exemplary embodiments of the present invention may be created by a computer executable program and implemented in a general use digital computer which operates the program using a computer readable recording medium.

The computer readable recording medium includes a magnetic storage medium (for example, a ROM, a floppy disk, and a hard disk) and an optical reading medium (for example, CD-ROM and a DVD).

For now, the present invention has been described with reference to the exemplary embodiments. It is understood to those skilled in the art that the present invention may be implemented as a modified form without departing from an essential characteristic of the present invention. Therefore, the disclosed exemplary embodiments may be considered by way of illustration rather than limitation. The scope of the present invention is presented not in the above description but in the claims and it may be interpreted that all differences within an equivalent range thereto may be included in the present invention.

1. A method for producing a 360-degree image for a predetermined space, the 360-degree image producing method comprising:
an information receiving step of receiving 360-degree image producing information including a plurality of camera images photographed using at least one camera, pose information which is information about a position and a direction of a camera which photographs the plurality of camera images, position information which is information about an origin position of the 360-degree image, depth information which is information about points corresponding to a plurality of depth values measured in the space, a camera model representing a correlation between a pixel included in the plurality of camera images and a point included in the depth information, and a 360-degree model representing a correlation between a pixel included in the 360-degree image and the point included in the depth information;
a target selecting step of selecting a depth information point corresponding to a target pixel which is included in the 360-degree image among a plurality of points included in the depth information, using the position information, the 360-degree model and the depth information;
an image pixel value acquiring step of acquiring a pixel value of a pixel of a camera image corresponding to the depth information point among the plurality of camera images using the pose information, the camera model, and the depth information; and
a target pixel constructing step of constructing a pixel value of the target pixel using the acquired pixel value of the camera image.

2. The 360-degree image producing method of claim 1, further comprising:
between the target selecting step and the image pixel value acquiring step,
a multiple correspondence confirming step of confirming whether the depth information point corresponds to pixels of two or more camera images among the plurality of camera images,
wherein in the target pixel constructing step, when the depth information point corresponds to the pixels of two or more camera images, a predetermined weight value is assigned to each of the pixels of two or more camera images to construct a pixel value of the target pixel.

3. The 360-degree image producing method of claim 2, further comprising:
a 360-degree image generating step of generating the 360-degree image by repeatedly applying the target selecting step, the image pixel value acquiring step, the multiple correspondence confirming step, and the target pixel constructing step to all pixels included in the 360-degree image.

4. The 360-degree image producing method of claim 3, further comprising:
a three-dimensional map generating step of generating a three-dimensional map of a virtual space corresponding to the space by projecting the generated 360-degree image to geometry information based on the depth information.

5. The 360-degree image producing method of claim 4, wherein
in the three-dimensional map generating step, a 360-degree image which represents an arbitrary field of view of the virtual space corresponding to the three-dimensional map is selected as a representative image and at least one 360-degree image other than the representative image to represent a missed field of view which cannot be represented by the representative image is designated as a supplementary image, and a weight value is assigned to information of the representative image and the supplementary image to generate a projected image corresponding to the arbitrary field of view to project the projected image onto the geometry information to generate a three-dimensional map.

6. An apparatus for producing a 360-degree image for a predetermined space, the 360-degree image producing apparatus comprising:
a receiving unit which receives 360-degree image producing information including a plurality of camera images photographed using at least one camera, pose information which is information about a position and a direction of a camera which photographs the plurality of camera images, position information which is information about an origin position of the 360-degree image, depth information which is information about points corresponding to a plurality of depth values measured in the space, a camera model representing a correlation between a pixel included in the plurality of camera images and a point included in the depth information, and a 360-degree model representing a correlation between a pixel included in the 360-degree image and the point included in the depth information;
a selecting unit which selects a depth information point corresponding to a target pixel which is included in the 360-degree image among a plurality of points included in the depth information, using the 360-degree model and the depth information;
an acquiring unit which acquires a pixel value of a pixel of a camera image corresponding to the depth information point among the plurality of camera images using the pose information, the camera model, and the depth information; and
a constructing unit which constructs a pixel value of the target pixel using the acquired pixel value of the camera image.

7. The 360-degree image producing apparatus of claim 6, further comprising:
a confirming unit which confirms whether the depth information point corresponds to pixels of two or more camera images among the plurality of camera images,
wherein when the depth information point corresponds to the pixels of two or more camera images, the constructing unit assigns a predetermined weight value to each of the pixels of two or more camera images to construct a pixel value of the target pixel.

8. The 360-degree image producing apparatus of claim 7, further comprising:
a generating unit which generates the 360-degree image by repeatedly applying the selecting unit, the acquiring unit, the confirming unit, and the constructing unit to all pixels included in the 360-degree image.

9. The 360-degree image producing apparatus of claim 8, wherein the generating unit further generates a three-dimensional map of a virtual space corresponding to the space by projecting the generated 360-degree image to geometry information based on the depth information.

10. The 360-degree image producing apparatus of claim 9, wherein the generating unit selects a 360-degree image which represents an arbitrary field of view of the virtual space corresponding to the three-dimensional map as a representative image and designates at least one 360-degree image other than the representative image as a supplementary image to represent a missed field of view which cannot be represented by the representative image and generates a projected image corresponding to an arbitrary field of view by assigning a weight value to information of the representative image and the supplementary image to project the projected image onto the geometry information to generate the three-dimensional map.
